(19) United States
(12) Patent Application Publication
(10) Pub. No.: US 2024/0023592 A1
(43) Pub. Date: Jan. 25, 2024

(54) FRUIT PROCESSING DEVICE

(71) Applicant: John Bean Technologies Corporation, Chicago, IL (US)

(72) Inventors: Ronald D. Johnson, Lakeland, FL (US); Philip G. Hebbler, Winter Haven, FL (US); Brandon R. Coles, Temple Terrace, FL (US)

(73) Assignee: John Bean Technologies Corporation, Chicago, IL (US)

(21) Appl. No.: 18/475,531

(22) Filed: Sep. 27, 2023

Related U.S. Application Data
(63) Continuation-in-part of application No. 18/049,842, filed on Oct. 26, 2022.
(60) Provisional application No. 63/263,259, filed on Oct. 29, 2021.

(51) Int. Cl. A23N 4/22; A23N 4/04

(52) U.S. Cl. CPC A23N 4/22; A23N 4/04

(57) ABSTRACT

A fruit processing apparatus includes a chute through which fruit passes to be placed into a series of holding cups positioned around the perimeter of a first rotating indexing delivery carousel. A second rotating indexing delivery carousel is located side by side the first delivery carousel and also includes a series of cups positioned around its perimeter. Two corresponding holding cups from the rotating delivery carousels close towards each other to cooperatively form a cavity to retain the fruit therein. A small separation remains between the two cups through which passes a splitting device for splitting, with one section/half remaining within each of the two cups. An ejector for ejecting the pit from the split fruit includes at least one pick configured to strike against the pit to remove the pit from the fruit.

### CROSS-REFERENCES TO RELATED APPLICATIONS

This application is a continuation-in-part of U.S. patent application Ser. No. 18/049,842, filed Oct. 26, 2022, which claims the benefit of U.S. Provisional Application No. 63/263,259, filed Oct. 29, 2021, the entire contents of both of which applications are expressly incorporated herein by reference.

### BACKGROUND

Currently, avocados and other “soft” fruit are processed manually where the corresponding pulp is required to remain intact. Not only is this a time-consuming, labor-intensive process, but it is also becoming difficult to attract workers who desire to perform this type of manual, repetitive work. Drum or roller squeeze systems currently exist that are capable of processing the avocado pulp into a paste or puree product. This processing method is not suitable where retaining chunks or solids content is required. For the US guacamole market, 30% solids or greater content is required by customers; for Asian markets, 50% or greater solids content is required. Avocado peelers exist for peeling the husk of the fruit, but do not split, pit, or dice or cut the fruit. These machines are semiautomatic and too slow to be cost effective for large-scale fruit processors.

Thus, there is an immediate industry need for an automated system and method of splitting and pitting the fruit and then removing the pulp from the husk in solid form. Moreover, it is desirable that the processing system be able to accommodate various sized fruit with various pit sizes, without having to change machine components while hygienically processing the fruit, with minimal damage to the pulp, and with minimal pulp loss. The system and method of the present disclosure seek to achieve these results.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an apparatus for processing fruit is provided. The apparatus includes flexible holding cups shaped for receiving a fruit; a splitting device to split the fruit while held by the holding cups, a plunger for ejecting the pit from the split fruit, a fruit pulp removal screen pressable into the holding cups to extract the fruit pulp from the fruit husk, and a collector to collect the fruit pulp extracted from the fruit husk by the removal screen.

In any of the embodiments described herein, wherein the holding cups are shaped to resemble the shape of the fruit being processed.

In any of the embodiments described herein, wherein the holding cups are of flexible construction to adapt to the shape and size of the fruit being processed.

In any of the embodiments described herein, wherein the holding cups are in the form of two halves that close towards each other to retain the fruit when being split by the splitting device.

In any of the embodiments described herein, wherein each holding cup retains half of the fruit after being split.

In any of the embodiments described herein, wherein a cover extends over the holding cups to retain a fruit half in the holding cup while the plunger operates to remove the pit from the fruit.

In any of the embodiments described herein, wherein the holding cups are located along the outer perimeter of a pair of delivery carousels that are disposed relative to each other to cause a holding cup from each delivery carousel to together hold the fruit being processed while maintaining a separation between the holding cups for passage of the splitting device during splitting of the fruit.

In any of the embodiments described herein, wherein the holding cups are formed in the perimeters of the delivery carousels.

In any of the embodiments described herein, wherein the fruit splitter is selected from the group consisting of a water jet, a saw, a knife.

In any of the embodiments described herein, wherein the plunger is positioned to extend through the holding cups and is in alignment with the pit of the fruit.

In any of the embodiments described herein, wherein the removal screen is formed in a convex exterior shape to engage into the holding cups and cause the fruit pulp to pass through the screen openings.

In any of the embodiments described herein, wherein the removal screen forces a fruit pit remaining in the holding cup out through the husk and out through the holding cup.

In any of the embodiments described herein, wherein the shape of the removal screen is selected from a shape selected from the group consisting of: the shape of the holding cup, the shape of the fruit, the shape of a prolate semi-spheroid, a semi-spherical shape.

In any of the embodiments described herein, wherein the removal screens are located along the outer perimeter of a removal carousel, the removal carousel rotating in synchronization with a corresponding delivery carousel to place a removal screen in registry with a holding cup.

In any of the embodiments described herein, further comprising a toggle assembly to toggle the removal screen within a holding cup to shear the fruit pulp from the husk.

In any of the embodiments described herein, wherein the removal screen is adapted to carry the fruit husk away from the holding cup.

In any of the embodiments described herein, further comprising a husk remover to remove the husk from the removal screen.

In any of the embodiments described herein, wherein the husk overlies the removal screen and the husk remover forces the husk off the removal screen by pressing against the portion of the husk overlying the removal screen.

In any of the embodiments described herein, wherein the husk remover is selected from the group consisting of a water jet, an air jet, a plunger.

In any of the embodiments described herein, further comprising a roller positioned to roll against the convex side of a holding cup to extract the husk from the holding cup if the husk remains within the holding cup after the fruit pulp is extracted from the husk.

In accordance with another embodiment of the present disclosure, a method is provided for processing fruit. The method includes placing a fruit in two adjacent holding cups shaped for together receiving the fruit, splitting the fruit while held by the holding cups, ejecting the pit from the split fruit, pressing removal screens into the split fruit to remove the fruit pulp from the husk by forcing the fruit pulp through the screen openings, and collecting the fruit pulp extracted from the fruit husk.

In any of the embodiments described herein, wherein the removal screens are toggled relative to the holding cups to shear the fruit pulp from the fruit husk.

In any of the embodiments described herein, further comprising splitting the fruit with a device selected from the group consisting of a water jet, a saw, a knife.

In any of the embodiments described herein, further comprising using a plunger to push the pit from the split fruit.

In any of the embodiments described herein, further comprising pressing the removal screen into the holding cup so that the husk becomes attached to the removal screen.

In any of the embodiments described herein, further comprising removing the husk from the removal screen.

In any of the embodiments described herein, wherein the husk is removed from the removal screen by applying a water jet, an air jet, or a plunger against the husk.

In any of the embodiments described herein, further comprising removing a husk that remains in a holding cup by flexing the holding cup to dislodge the husk from the holding cup.

In accordance with another embodiment of the present disclosure, an apparatus is provided for processing fruit. The apparatus includes: (a) holders configured for receiving a fruit having a pit while moving in a fixed path; (b) a cutting device to cut the fruit through the pit while held by the holders moving in the fixed path; and (c) an ejector for ejecting the pit from the split fruit held by the holders, the ejector comprising at least one pick configured to strike against the pit to remove the pit from the fruit.

In any of the embodiments described herein, wherein the at least one pick pivots about an axis to cause the at least one pick to strike against the pit.

In any of the embodiments described herein, wherein the location of the at least one pick is adjustable toward and away from the holder.

In any of the embodiments described herein, further comprising an actuator acting on the at least one pick to strike against the pit.

In any of the embodiments described herein, wherein the actuator comprises a cam moving with the holders and a cam follower on which the at least one pick is mounted, the cam follower resiliently biased in engagement with the cam.

In any of the embodiments described herein, wherein the holders are arranged in a circular array about a rotational axis and the cam extends along the circular array to define a circumferential undulating cam surface that rotates with the holders around the rotational axis.

In any of the embodiments described herein, wherein the cam follower is mounted about a pivot axis, the cam follower following the cam surface resulting in the pivoting movement of the cam follower and a corresponding pivoting movement of the at least one pick toward and away relative to the holders.

In any of the embodiments described herein, wherein the cam follower comprises an elongate pivot arm having an end portion following the cam surface, the pivot axis of the cam follower located along the length of pivot arm at a location spaced from the end portion.

In any of the embodiments described herein, wherein the elongate pivot arm is biased to rotate about the pivot axis to press the end portion of the cam follower toward the cam surface.

In any of the embodiments described herein, wherein the actuator comprises a spring acting on the pivot arm to bias the pivot arm to rotate about the pivot axis.

In any of the embodiments described herein, wherein the at least one pick is mounted on the elongate pivot arm in adjustable position toward and away from the holders.

In any of the embodiments described herein, wherein the holders are shaped to resemble the shape of the fruit being processed.

In any of the embodiments described herein, wherein a cover extends over the holders to retain a fruit half in the holder while the ejector operates to remove the pit from the fruit.

In any of the embodiments described herein, wherein the holders are mounted on a rotating ring structure and the ejector is located relative to the ring structure to position the ejector-pick relative to the passing fruit held in the holders to strike and eject the pit from the fruit.

In any of the embodiments described herein, wherein the pick is selected from the group consisting of a blade, knife, tip, rod, bar, spear, and spike.

In accordance with another embodiment of the present disclosure, a method is provided for processing fruit. The method includes: (a) placing a fruit in two adjacent holders shaped for together receiving the fruit; (b) splitting the fruit while held by the holders; and (c) ejecting the pit from the split fruit by striking at least one pick against the pit to dislodge the pit from the fruit.

In any of the embodiments described herein, wherein the holders are rotated about a central axis and the at least one pick is moved into the path of the fruit to strike the pit on the moving fruit.

In any of the embodiments described herein, further comprising swinging the at least one pick to cause the pick to strike against the pit.

In any of the embodiments described herein, further comprising acting on the at least one pick with an actuator.

In any of the embodiments described herein, further comprising timing the striking of the at least one pick against the pit with a cam structure.

In accordance with another embodiment of the present disclosure, an apparatus is provided for processing fruits and vegetables. The apparatus includes: (a) holders configured for receiving fruits or vegetables having an interior component differing from the surrounding pulp while the fruits or vegetables moves in a fixed path; (b) a cutting device to cut the fruits or vegetables through the interior component while held by the holders moving in the fixed path; and (c) a scraper device to cut the interior component from the surrounding pulp for removal of the interior component from the surrounding pulp while the fruits or vegetables are held by the holders moving in the fixed path.

### DESCRIPTION OF THE DRAWING

The foregoing aspects and many of the attendant advantages of this invention will become more readily appreciated as the same become better understood by reference to the following detailed description, when taken in conjunction with the accompanying Figures.

FIG. 1 schematically illustrates an exemplary fruit processing apparatus and method of the present disclosure;

FIG. 2 is an isometric view of another exemplary fruit processing apparatus of the present disclosure;

FIG. 3 is a front elevational view of FIG. 2, with certain components removed;

FIG. 4 is an enlarged fragmentary view of FIG. 3;

FIGS. 5A-5D are enlarged fragmentary views of FIG. 4;

FIG. 6 is an exploded view of FIG. 2;

FIG. 7 is an enlarged, fragmentary cross-sectional view of FIG. 2;

FIGS. 8A and 8B are isometric views of an exemplary ejector used to eject the fruit pit.

### DETAILED DESCRIPTION

In the following description and in the accompanying drawing, corresponding systems, assemblies, apparatus, and units may be identified by the same part number, but with an alpha suffix. The descriptions of the parts/components of such systems assemblies, apparatus, and units that are the same or similar are not repeated so as to avoid redundancy in the present application.

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These are meant to serve as modifiers to indicate that the “dimension,” “shape,” “temperature,” “time,” or other physical parameter in question need not be exact, but instead may vary as long as the function that is required to be performed can be carried out. For example, in the phrase “generally circular in shape,” the shape need not be exactly circular as long as the required function of the structure in question can be carried out.

The system and method of the present disclosure can also be used with other types of fruits and vegetables beyond avocados. For example, the system and method of the present disclosure can also be used with plums, cherries, peaches, nectarines, and olives.

Further the system and method of the present invention can be used beyond the extraction of pits or stones from fruits and vegetables. For example, the system and method of the present disclosure can be used to remove seeds, pips, wooding content, or other unwanted content within fruits or vegetables.

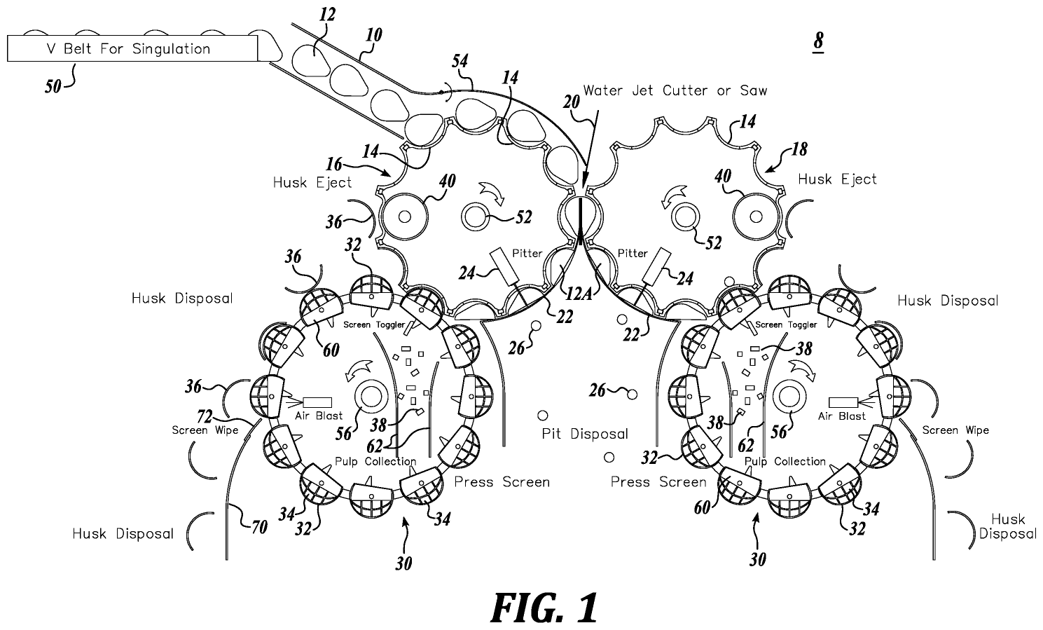

A fruit processing apparatus 8 is disclosed in FIG. 1 as including, in basic form, a chute 10 through which fruit 12 travel from a supply source and into one of a series of holding cups 14, or simply cups 14, positioned around the perimeter of a first rotating indexing delivery wheel or carousel 16. A second rotating indexing delivery wheel or carousel 18 is located side by side the first delivery carousel 16. The second delivery carousel 18 also includes a series of cups 14 positioned around its perimeter. Two corresponding cups 14 from the rotating delivery carousels 16 and 18 close towards each other to cooperatively form a cavity to retain the fruit 12 therein.

However, a small separation remains between the two cups 14 through which passes a splitting device 20 for splitting the fruit in two sections or halves 12A, with one section/half remaining within each of the two cups 14. As the delivery carousels 16 and 18 continue to rotate, the two cups 14 separate from each other after the splitting of the fruit, whereupon covers 22 extend over the cups 14 to retain the fruit halves 12A therein.

A pitter 24, for example, in the form of a plunger projects forwardly through the fruit husk 36 and against the fruit pit 26 to eject the pit from the fruit.

A rotating indexing removal wheel or carousel 30 is positioned adjacent and in close proximity to each of the delivery carousels 16 and 18. A series of radially outwardly projecting removal screens 32 are positioned around the perimeters of the removal carousels 30. The removal screens 32 are configured to press into the fruit halves 12A disposed in the holding cups 14 to force the fruit pulp 38 out through the screen openings 34, thereby to extract the fruit pulp 38 from the husk 36 in the form of cubes or other desirable shapes.

If, after the extraction of the fruit pulp 38, the husk 36 remains in the cup 14, a roller 40 presses against the convex surface of the cup to eject the husk 36 from the cup. If, on the other hand, the husk 36 is transferred to a removal screen 32, the husk is ejected from the removal screen by an air blast or other means.

Next describing the fruit processing apparatus 8 in more detail, fruit 12 is delivered to the chute 10 in single file from a V belt conveyor 50 or other delivery mechanism wherein the fruit has been or is singulated so as to enter the chute one at a time. This enables each fruit 12 to be loaded on to a cup 14 by gravity as the cup is rotating near the top of the carousel 16. Although not essential, the cups 14 may be shaped to generally correspond to the shape of the fruit. For example, if the fruit is oblong in shape, the cups may also be oblong in shape in the direction of the circumference of the delivery carousels 16 and 18. However, if the fruit is substantially spherical in shape, then the cups 14 may be generally semi-spherical in shape.

In addition, the cups 14 may be composed of a flexible, but durable, material so as to conform or adapt to the size and exterior shape of the fruit 12. The cups 14 may be mounted to the outer perimeter of the delivery carousels 16 and 18. In this regard, the cups are attached in place so as to provide clearance behind the cups to enable the cups to conform to the shape of the fruit 12. Alternatively, the cups may be integrally constructed as part of the delivery carousels 16 and 18. In this alternative configuration, clearance is provided behind the base of the cups to allow the cups to flex or otherwise conform to the shape of the fruit 12.

The delivery carousels 16 and 18 are depicted as having twelve cups 14 each. However, the number of cups associated with each of the delivery carousels 16 and 18 may be fewer in number or greater in number depending on various factors, for example, the size of the fruit 12 being processed and the speed of operation of the processing system 8.

The delivery carousels 16 and 18 are depicted in FIG. 1 as rotated on axles 52, which are in turn powered by a drive system in a synchronized manner so that the cups 14 of the carousels align with each other when the cups come together, as discussed below. As the fruit 12 travels from the top of carousel 16 and downwardly towards carousel 18, the fruit is held within the cups 14 of carousel 16 by a cover 54 extending from the end of the chute 10. As shown in FIG. 1, the cover 54 is curved to correspond to the curved perimeter defined by the fruit being carried in the cups 14. The cover 54 terminates at a location just short of the delivery carousel 18, whereupon the fruit 12 is captured by the cups 14 of both delivery carousels 16 and 18.

As noted above, when the two corresponding cups 14 are positioned at their closest locations relative to each other, they cooperatively form a cavity for retaining and holding the fruit 12 therein. However, the holding cups 14 of the delivery carousels 16 and 18 do not actually touch each other, but rather a small gap or slot exists there between. The splitting device 20 passes through the gap between the cups 14 to split the fruit 12 into two sections or halves 12A.

The splitting device 20 can take various forms. For example, the splitting device can be in the form of a high-speed water jet that passes through the gap. As further examples, the splitting device can be in the form of a saw or a knife. If a knife, it can be in the form of a rotating blade that is capable of quickly passing through the gap.

Curved covers 22 extend along the perimeter of delivery carousels 16 and 18 from the splitting gap to a location close to the perimeter of the removal carousels 30 to retain the fruit sections 12A in corresponding cups 14. The covers 22 can continue to extend along a portion of the removal carousels 30 as shown in the Figure. The covers 22 need not be of solid construction, but can be in the form of, for example, spaced apart rails so that the fruit pits 26 can pass through the covers (between the rails) when ejected by the pitter 24.

The pitter 24 is illustrated as being in the form of a plunger extending through the holding cup 14 and the husk 36 to impact against the fruit pit 26, causing the pit to be ejected through the cover 22 to fall downwardly into a disposal location. A collection bin or other receptacle system can be used to collect the pits 26 for disposal or for use, such as compost. The pitter 24 can take forms other than as illustrated. Also, a slot or other configuration of opening can be formed in the cup to allow clearance for the plunger when extended to eject the pit 26.

The removal carousels 30 rotate on axles 56 in synchronization with the delivery carousels 16 and 18 so that removal screens 32 coincide with the locations of the cups 14. As such, a removal screen 32 engages into a holding cup 14 as the delivery carousel 16 and 18 and the removal carousels 30 continuously rotate. The axles 56 may be driven by the same drive system used to drive axles 52.

The removal screens 32 can be of various shapes or configurations. As one example, as shown in FIG. 1, the removal screen 32 is generally semi spherical in shape so as to generally match the shape of the holding cup 14. If the cup 14 is of a different shape, such as in the form of a prolate semi-spheroid, then the removal screen can be correspondingly shaped. The screen will be made of stainless steel or other hygienic material (round, flat, or geometrical). The openings in the screen can be of various sizes and geometric shapes, depending on the intended use of the pulp.

The removal screen 32 is mounted on an open swivel base 60 to support the removal screen as the screen enters into the fruit husk 36, thereby pressing through the fruit pulp. This action of the removal screen causes the fruit pulp to pass though the screen openings and fall downwardly through the open base 60 and into a pulp collection area. In this regard, the base 60 is toggled relative to the husk 36 to shear the pulp from the husk. The toggling can be accomplished via a cam system operating between the base 60 and the carousel 30, by an actuator acting on the base 60, or by another system. Partitions 62 can be positioned below the open base 60 to direct the removed fruit pulp 38 to the collection area.

Through this process, the fruit pulp 38 is divided into shapes having a cross-section corresponding to the shape of the openings in the removal screen. For example, if the screen openings are square in shape, the fruit pulp 38 will be square in cross-section. As such, the fruit pulp 38 when removed from the husk will be divided generally into cubes or cube-like shapes. On the other hand, if the screen openings are triangular in shape, the fruit pulp is divided into shapes having a triangular cross section.

The machine can also be adapted with different screens to produce fruit slices, halves, or full or depth-controlled segments. For example, if larger fruit is being processed, the removal screen system could be designed to penetrate part way into the husk and then the screen toggled so that cube-shaped pieces (or other shapes) of the pulp are formed, and then penetrating to the husk to cut a second set of cube-shaped pieces from the pulp.

If the pitter 24 fails to remove the fruit pit 26 from the fruit half 12A, the removal screen 32 presses the pit through the husk 36 and then out through the holding cup 14 for disposal.

Once the fruit pulp has been separated, the husk 36 is removed from the holding cup 14. In this regard, if the husk 36 remains in the holding cup 14, a roller 40 is used to roll against the convex side of the holding cup to sufficiently flex or otherwise deform the holding cup as shown in FIG. 1, which causes the husk to detach from the cup. The detached husk 36 is directed to a husk collection area for disposal. In this regard, a partition 70 can be used to help direct the detached husk 36 to the collection area.

If the husk 36 does not remain within the cup 14, but instead is transferred to the removal screen 32, the husk can be removed from the removal screen, for instance, by directing a blast of air through the open base 60 of the removal screen, thereby to detach the husk from the removal screen, causing the husk to fall downwardly into the collection area. Again, in this regard, the partition 70 can be used to direct the detached husk to the collection area.

After removal of the husk 36 from the removal screen 32, the screen is cleaned before it again functions to remove the fruit pulp 38 from the fruit sections 12A. In this regard, a wiper 72 can be used to wipe the pulp from the exterior of the screen. Also, pressurized air or water can be directed to and through the removal screen to remove any fruit pulp that may have lodged on the screen. Thereafter, the removal screen 30 continues along a rotational path to encounter a removal cup 14 to repeat the process of harvesting the fruit pulp 38.

While illustrative embodiments have been illustrated and described, it will be appreciated that various changes can be made therein without departing from the spirit and scope of the invention.

For example, although one set of delivery carousels 16 and 18, with corresponding removal carousels 30, are shown in FIG. 1, to increase production, one or more further sets of delivery carousels 16 and 18, along with corresponding removal carousels 30, can be located in adjacent relationship to the depicted carousels 16, 18, and 30. The one or more further sets can be driven by the same axles 52 and 56.

A desired production speed is to process at least two fruits (item 12) per second. It is possible that this production level can be met with one set of delivery carousels 16 and 18 and corresponding removal carousels 30. But, if need be, or if a higher production level is desired, as noted above additional sets of delivery and removal carousels can be used.

Also, the present apparatus and method can be used to process various types of fruits, including, for example, avocados, kiwi, mango, melons, and cantaloupe. Each of these types of fruits have a substantial husk. The present disclosure can be used with other types of fruits with or without substantial husks, such as papaya, or even with vegetables, such as squash or pumpkin. If the fruit/vegetable does not have a pit, but instead has seeds or woody content at its center, the pitter 24 can be replaced with a scraper or other tool to remove the seeds/woody content prior to collecting the fruit pulp.

In addition, the removal screen can be configured as a series of curved, parallel spaced-apart blades that cut the fruit pulp 38 into slices as the removal screen is pressed into the husk. The slices are removed from the husk as the blades are toggled relative to the husk in the manner described above. If the toggling occurs about a horizontal axis, the blades can be disposed in a vertical orientation, so that the slices are sheared from the husk during the toggling.

Further, the removal screen can be configured to cut the fruit pulp into halves, quarters, etc. as desired. The removal screen thus configured can be operated in the same manner as described above.

Further, the holding cups 14 positioned around the perimeter of a first and second rotating indexing delivery wheels or carousels 16 can be of constructions other

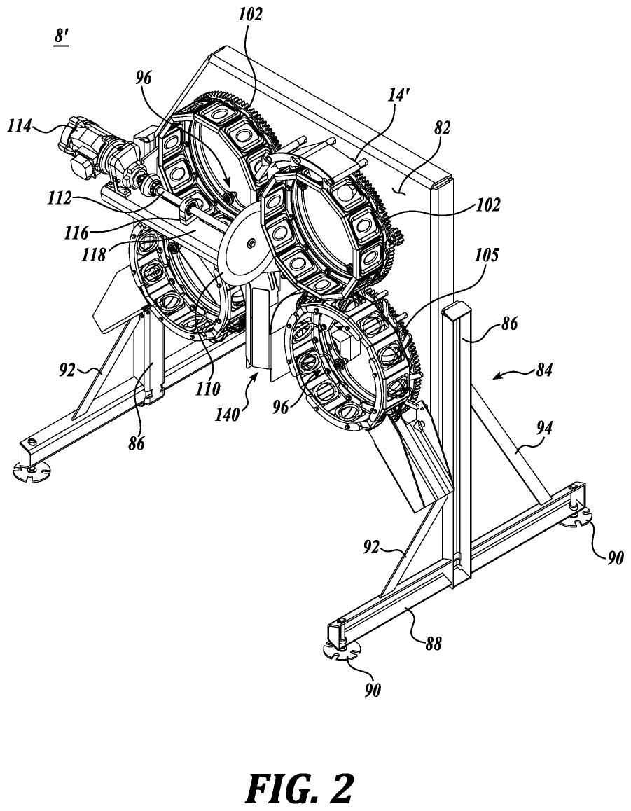

FIGS. 2-8B illustrate a second embodiment of the present disclosure that differs in one respect from the first embodiment of FIG. 1 in the manner the pit 26 is removed from the fruit 12. The aspects of the second embodiment that are the same or similar to the first embodiment will not be repeated here. Also, the components or parts that are similar between the two embodiments are identified by the same part number but with prime (′) designation.

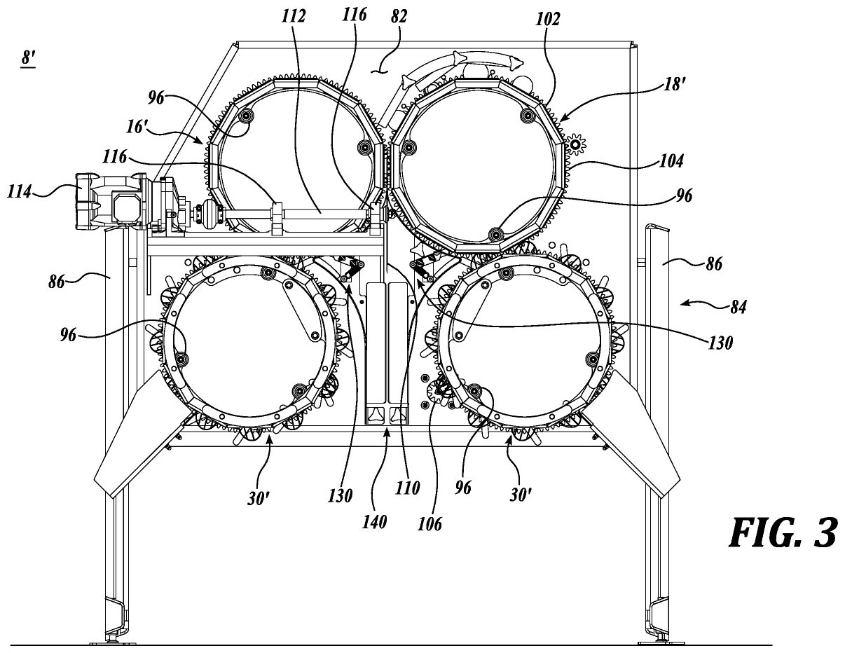

The delivery carousels 16′ and 18′ are shown in FIGS. 2-3 as rotatably mounted on an upright wall 82 of a frame structure 84. The wall 82 is supported in vertical orientation by arms 86 extending upwardly from horizontal base members 88. Vertically adjustable feet 90 are engaged with each end of the base members 88.

Diagonal braces 92 and 94 extend between the upright arms 86 and the horizontal base members 88. Additional or other types of bracing can be used to enhance the structural integrity and stiffness of the frame 84.

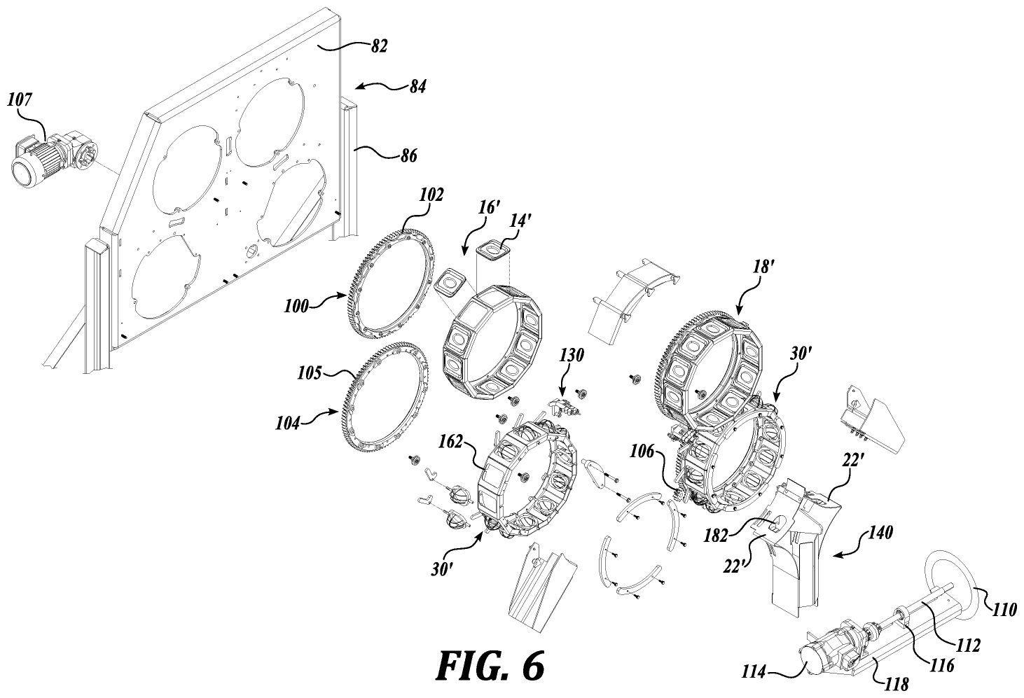

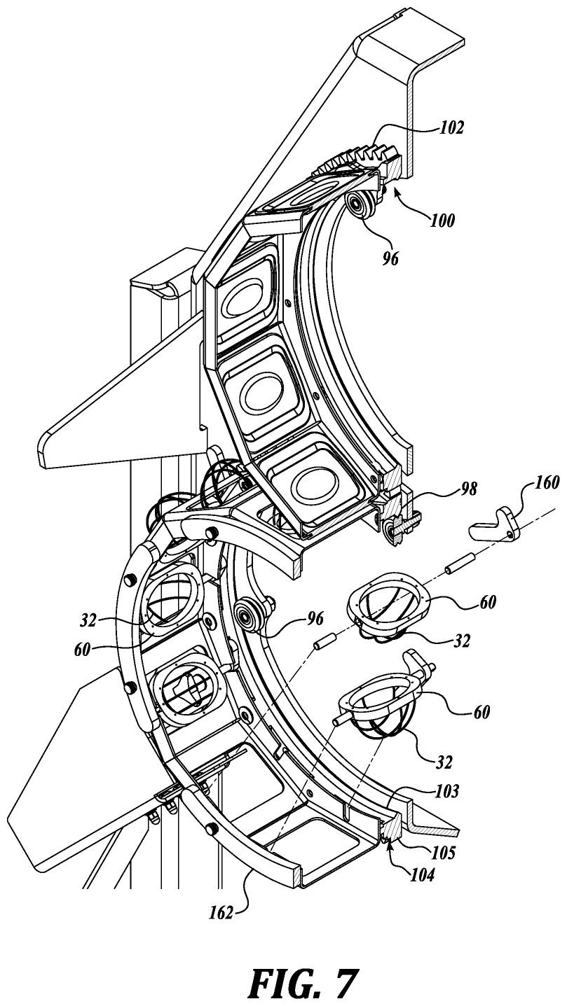

Additionally referring to FIGS. 6 and 7, the delivery carousels 16′ and 18′ are attached to the upright wall 82 by three roller assemblies 96. Each roller assembly 96 is anchored to the upright wall in position to roll against an inner circumferential edge 98 of a ring structure 100. The ring structure 100 defines an annular ring gear 102. The cups 14 are attached to an annular face of the ring structure opposite the ring gear 102. The ring gears 102 of the delivery carousel 16′ and 18′ are rotatably driven as described below.

The ring gear 102 of the delivery carousel 16′ engages with the ring gear 102 of the delivery carousel 18′. In this manner, the rotation of the carousels 16′ and 18′ are synchronized so that the corresponding cups 14′ of the two carousels are in registry with each other to receive and support the fruit 12 when the fruit is split or cut by the splitting device 20′.

The two removal carousels 30′ are constructed similarly to the delivery carousels 16′ and 18′. In this regard, the removal carousels 30′ are mounted on the upright wall 82 of the frame structure 84 at locations below and slightly outwardly of corresponding delivery carousels 16′ and 18′ by three roller assemblies 96 anchored on the upright wall 82. Each roller assembly 96 rolls against an inner circumferential edge 103 of a ring structure 104. The ring structure 104 defines an annular ring gear 105. The removal screens 32 and their bases 60 are mounted to an annular face of the ring structure 104 opposite the ring gear 105.

The ring gear 105 of a removal carousel 30′ engages with the ring gear 102 of the delivery carousel 18′ to be driven by the ring gear 105 of the carousel 18′ as described below. Similarly, the ring gear 105 of a removal carousel 30′ engages with the ring gear 102 of the delivery carousel 16′. The delivery carousels 16′ and 18′ and the removal carousel 30′ are all driven by the ring gear of the removal carousel 30′ that is engaged with the delivery carousel 18′. In this manner the rotation of the delivery carousels 16′ and 18′ are synchronized with corresponding removal carousels 30′ so that the corresponding cups 14′ of the delivery carousels are in registry with a corresponding removal screens 32 of the removal carousels 30′.

The carousels 16′, 18′, and 30′ are rotatably driven in unison, as described above. In this regard the ring gear 105 of the removal carousel 30′ located beneath delivery carousel 18′ is engaged with a drive gear 106 driven by a motor 107 located on the backside of the upright wall 82. Of course, the drive gear 106 can be driven by numerous other means. Further, the drive gear 106 can be engaged with a different ring gear than as shown and described.

Referring primarily to FIGS. 2 and 3, a splitting device 20′ is used to split the fruit 12 while being supported by corresponding cups 14′ of the rotating carousels 16′ and 18′, as described above. The splitting device 20′ includes a thin circular saw blade 110 that engages within the narrow gap between corresponding cups 14′ of carousels 16′ and 18′ when in registration with each other and when in closest proximity to each other.

The circular saw blade 110 is mounted on the distal end of a drive shaft 112. The proximal end of the drive shaft is driven by a motor 114. The drive shaft is rotatably supported in position by a pair of spaced apart pillow blocks 116 mounted on a horizontal ledge member 118. The ledge member is in turn fixed to the upright wall 82. Although not illustrated, a shield can be placed over the top of the drive shaft 112 and motor 114 to deflect or otherwise keep away the fruit 12 and parts thereof.

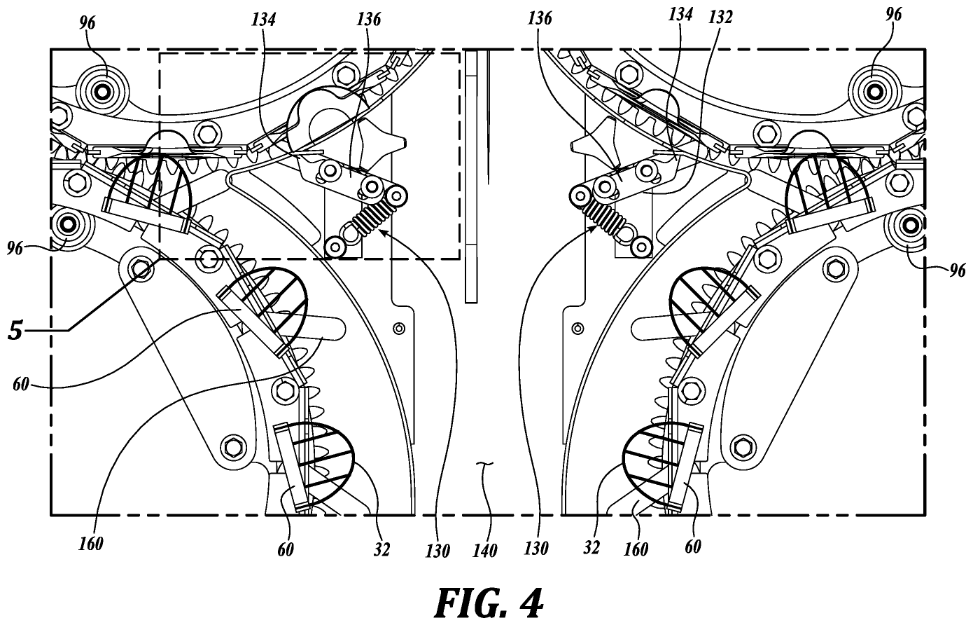

Referring primarily to FIGS. 4, 5A-5D, 8A, and 8B, once the fruit 12 has been split, halves of the fruit pit 26 that remain in place are removed with an ejector 130 that operates to strike against one side of the pit halves to eject the pit halves out of the location where the pit halves are seated in the fruit. The ejector 130 includes a set of side-by-side blades 132 each having a formed pointed tip 134 that is designed to penetrate a short distance into the fruit being carried by the rotating the delivery carousels 16′ and 18′ to strike against the exterior of the pits.

The blades 132 each include an elongated shank section 136 that used to mount the blades on an actuator which in turn propels or swings the blades in a desired path to eject the pit halves from the fruit. The actuator includes an elongated cam follower 138. The cam follower 138 is pivotally mounted at a location intermediate the ends of the cam follower by a pivot bolt 139 to a subframe structure 140 that is in turn detachably mountable to the upright wall 82 along the underside of the delivery carousels 16′ and 18′.

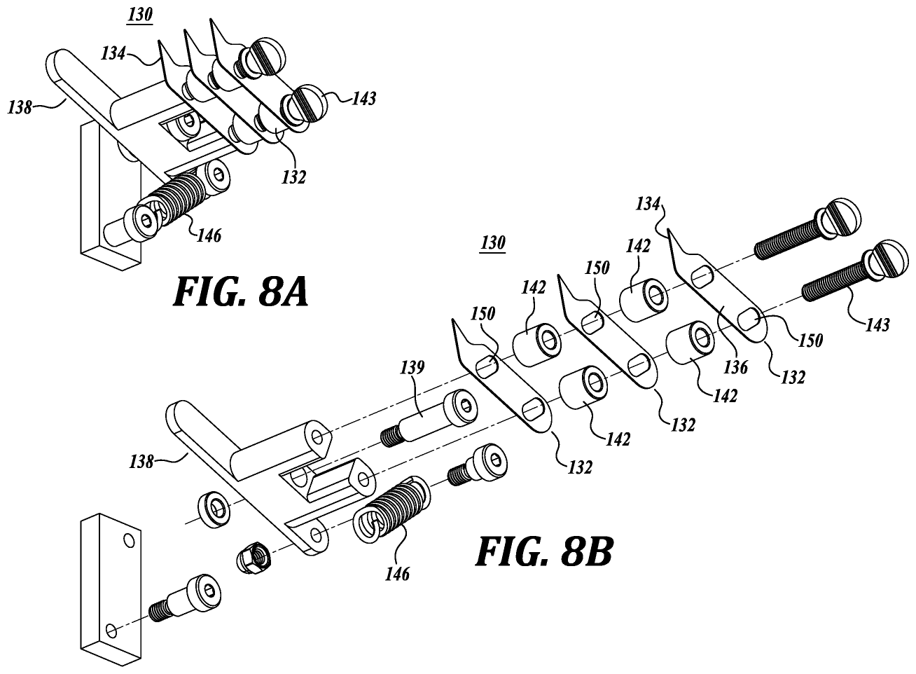

FIGS. 8A and 8B depict three blades 132 positioned side-by-side to each other by spacers 142. Thumb screws 143 fasten the blades 132 to the cam follower 138. Of course, other types of hardware member can be used in place of thumb screws 143.

Also, depending on the situation, a fewer number or a larger number of blades can be used to remove the fruit pit. In addition, the shape and length of the blade tip can be altered based on the size and type of fruit being processed.

It is to be appreciated that the blades 132 can be replaced by other types of pick instruments or devices. For example, a hook, a tip, a rod, a knife, a shank, a bar, a spear, or a spike could be used as a pick instrument in place of the blade 132.

The cam follower 138 has a rounded leading end that rides along a cam surface 144 that extends around the ring structure 100. It will be appreciated that the cam surface 144 also functions as a part of the actuator for the blades 132.

The opposite end of the cam follower is attached to one end of an extension spring 146. The other end of the extension spring is anchored to the subframe structure 140. The extension spring resiliently loads the leading end of the cam follower 138 against the cam surface 144.

A roller, not shown, can be axled at the leading end of the cam follower 138 to roll along the cam surface 144. The roller would reduce the drag between the cam follower 138 and cam surface 144.

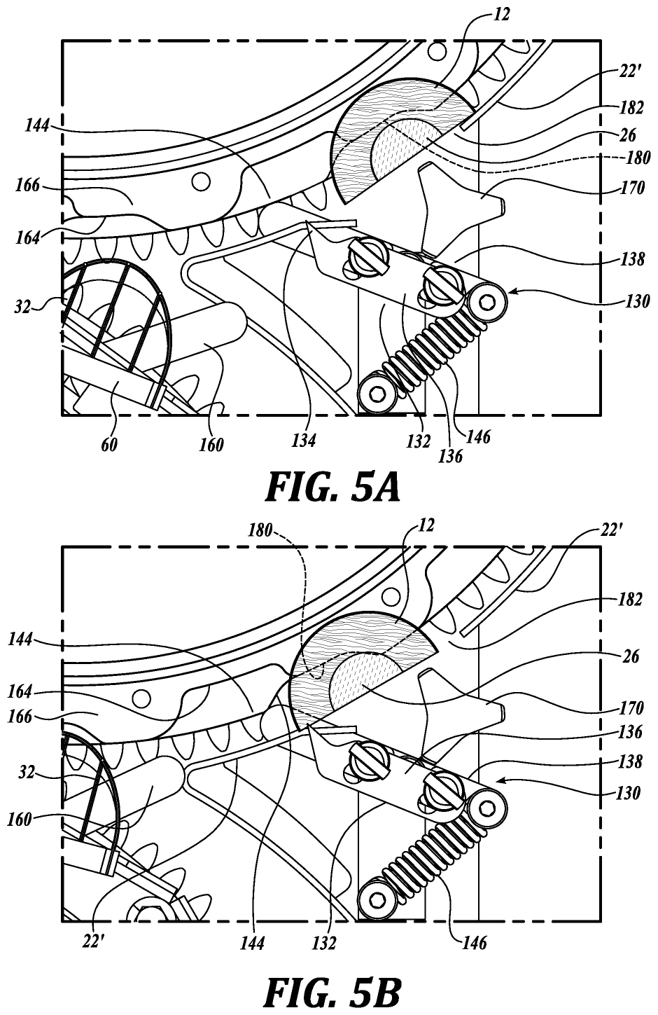

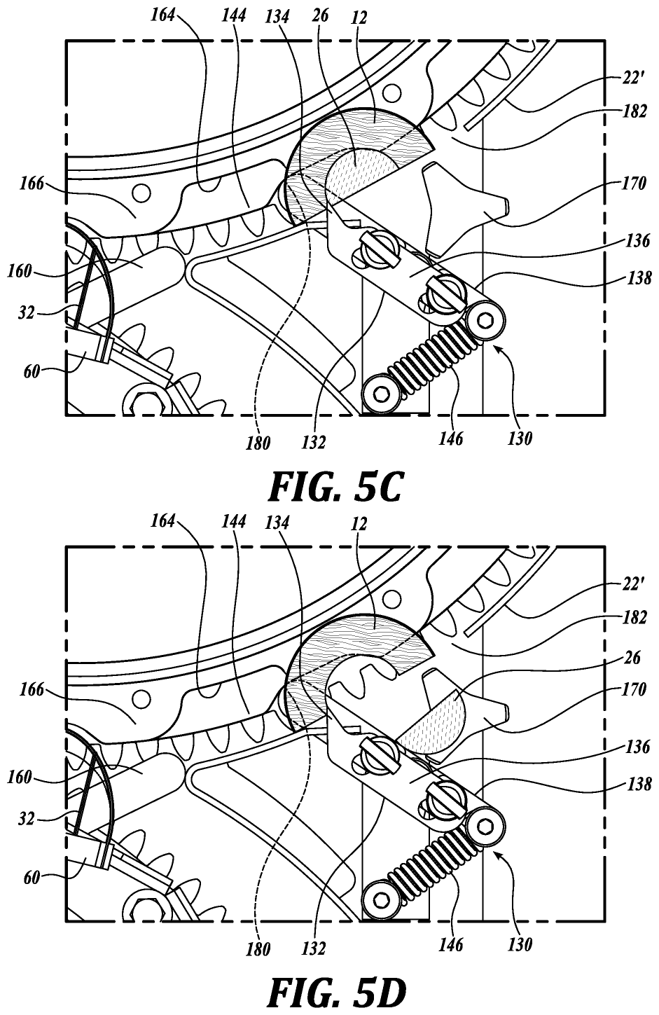

As shown in FIGS. 5A-5D, 8A, and 8B, transverse slots 150 are formed in the shank section 136 of the blades 132. The slots 150 enable the positions of the blades to be changed relative to the cam follower, to accommodate different sized fruit 12 by moving the blade tip 134 closer to or further from the fruit pit 26, as described more fully below.

As noted above, the base 60 that supports a removal screen 32 is toggled relative to the husk 36 to cause the screen 32 to shear the pulp from the husk, thus separating the pulp from the husk. One way of toggling the removal screen 32 is shown in FIGS. 4 and 5A-5D. A toggle arm 160 is attached to the base 60 which in turn is pivotally mounted on a circular, segmented frame 162 that is in turn mounted the ring structure 104.

As the removal screen approaches a cup 14, the distal end of the toggle arm 160 extends into a valley 164 of a circumferential cam 166 that extends around the ring structure 100 of a delivery carousel. The circumferential cam 166 is side by side with the ejector cam 144, but outwardly of the ejector cam relative to the location of the ring gear 102.

After the removal screen 32 engages a cup 14, the distal end of the toggle arm 160, leaves the cam valley 164 causing toggle arm to ride along the circumferential exterior of the cam 166, which in turn causes the base 60 to rotate and thus toggle the screen relative to the fruit husk. As a result, the fruit pulp is shared from the husk and causes the fruit pulp to fall downward into a collection area.

As with cam follower 138, a roller, not shown, can be axled at the leading ends of the toggle arms 160 to roll along the surface of cam 166. The roller would reduce the drag between the ends of the toggle arms 160 and the surface of cam 166.

Although the cams 144 and 166 are shown as being integrally formed on ring structure 100, the cams could instead be composed of separate plates that are bolted or otherwise attached to the ring structure. This would facilitate changing the shapes of the cams to, for example, accommodate different types and/or sizes of fruit being processed.

As noted above, subframe 140 functions to mount the ejectors 130 in place relative to the delivery carousels 16′ and 18′. The covers 22′ that hold the split fruit 12 in cups 14 also form a part of the subframe 140. The subframe 140 is designed to be quickly and easily removed from its attachment to the frame wall 82 by knob screws 170. This facilitates the ability to conveniently clean the processing system 8′.

FIGS. 5A-5D illustrate the operation of the ejector 130. In FIG. 5A, the fruit 12, having been cut in half, approaches the ejector. The cam follower 138 is riding along the cam 144 at the maximum outer perimeter of the cam. As such, the ejector blades 132 are in retracted position.

In FIG. 5B, the fruit is at or is near the ejector blade tips 134. The cam follower 144 is about to leave the maximum outer perimeter of the cam 144 and drop down into a valley 180 formed in the cam surface. This will cause the blades 132 to quickly rotatably snap about the pivot axis of the cam follower due to the load on the distal end of the cam follower be applied by spring 146.

In FIG. 5C, the cam follower has snapped into the cam valley 180 under the force of the spring 146. This causes the blade 132 to quickly rotate, with the swinging blade tip missing the fruit husk 36 and impacting against the exterior of the fruit pit 26, thereby to “flip” the pit out of the fruit pulp. As shown in FIG. 5D, the pit passes through the opening 182 in the cover 22′ and down into a collection area.

As the carousel 16′ continues to rotate, the cam follower rides along the length of the cam valley 180 and up to the maximum outer perimeter of the of the cam surface. This causes the blades 132 to be retracted into the spring loaded position to await the next approaching fruit half.

Although the above description was directed to carousel 16′, the ejector 130 for carousel 18′ is the same but mounted in the opposite direction so as to operate with carousel 18′.

If a different fruit or fruit of a different size is to be processed, the position of the blades 132 on the cam follower 138 can be changed by loosening the thumb screws 143 and moving the blades along the slots 150. As can be appreciated, this adjustment of the position of the blades can position the blade tips 134 closer to or further away from the fruit pit 26. As a result, when the ejector 130 is actuated, the blade tips will be in proper position to strike the fruit pit and eject the fruit pit from the fruit.

Further, the holding cups 14 and 14′ positioned around the perimeter of a first and second rotating indexing delivery wheels or carousels 16, 16′ and 18, 18′ can be of constructions other than described above and shown in the drawings. For example, a holder composed of a single rod, bar or strap could be used with pads attached to the rod/bar/strap to retain the fruit in place. Numerous other constructions of holders can be used the retain the fruit in place relative to the delivery wheels or carousels 16, 16′ and 18, 18.′

In addition, the blades 132 could be replaced with a scraper to scrape the seeds or woody content out of the interior of a kiwi, mango, melon, cantaloupe, pumpkin, squash, yuca, cassava or other fruit or vegetable. The scraper can take various forms and shapes, for example, a curved shape or the shape of partial sphere, thereby to resemble the shape of the interior of the fruit or vegetable being processed.

While illustrative embodiments have been illustrated and described, it will be appreciated that various changes can be made therein without departing from the spirit and scope of the invention.

The embodiments of the invention in which an exclusive property or privilege is claimed are defined as follows:

1. An apparatus for processing fruit, comprising:
(a) holders configured for receiving a fruit having a pit while moving in a fixed path;
(b) a cutting device to cut the fruit through the pit while held by the holders moving in the fixed path;
(c) an ejector for ejecting the pit from the split fruit held by the holders, the ejector comprising at least one pick configured to strike against the pit to remove the pit from the fruit.

2. The apparatus of claim 1, wherein the at least one pick pivots about an axis to cause the at least one pick to strike against the pit.

3. The apparatus of claim 2, wherein the location of the at least one pick is adjustable toward and away from the holder.

4. The apparatus of claim 1, further comprising an actuator acting on the at least one pick to strike against the pit.

5. The apparatus of claim 4, wherein the actuator comprises a cam moving with the holders and a cam follower on which the at least one pick is mounted, the cam follower resiliently biased in engagement with the cam.

6. The apparatus of claim 5, wherein the holders are arranged in a circular array about a rotational axis and the cam extends along the circular array to define a circumferential undulating cam surface that rotates with the holders around the rotational axis.

7. The apparatus of claim 6, wherein the cam follower is mounted about a pivot axis, the cam follower following the cam surface resulting in the pivoting movement of the cam follower and a corresponding pivoting movement of the at least one pick toward and away relative to the holders.

8. The apparatus of claim 7, wherein the cam follower comprises an elongate pivot arm having an end portion following the cam surface, the pivot axis of the cam follower located along the length of pivot arm at a location spaced from the end portion.

9. The apparatus of claim 8, wherein the elongate pivot arm is biased to rotate about the pivot axis to press the end portion of the cam follower toward the cam surface.

10. The apparatus of claim 9, wherein the actuator comprises a spring acting on the pivot arm to bias the pivot arm to rotate about the pivot axis.

11. The apparatus of claim 8, wherein the at least one pick is mounted on the elongate pivot arm in adjustable position toward and away from the holders.

12. The apparatus of claim 1, wherein the holders are shaped to resemble the shape of the fruit being processed.

13. The apparatus of claim 1, wherein a cover extends over the holders to retain a fruit half in the holder while the ejector operates to remove the pit from the fruit.

14. The apparatus of claim 2, wherein the holders are mounted on a rotating ring structure and the ejector is located relative to the ring structure to position the ejector pick relative to the passing fruit held in the holders to strike and eject the pit from the fruit.

15. The apparatus of claim 1, wherein the pick is selected from the group consisting of a blade, knife, tip, rod, bar, spear, and spike.

16. A method for processing fruit, comprising:
(a) placing a fruit in two adjacent holders shaped for together receiving the fruit;
(b) splitting the fruit while held by the holders;
(c) ejecting the pit from the split fruit by striking at least one pick against the pit to dislodge the pit from the fruit.

17. The method of claim 16, wherein the holders are rotated about a central axis and the at least one pick is moved into the path of the fruit to strike the pit on the moving fruit.

18. The method of claim 16, further comprising swinging the at least one pick to cause the pick to strike against the pit.

19. The method of claim 16, further comprising acting on the at least one pick with an actuator.

20. The method of claim 16, further comprising timing the striking of the at least one pick against the pit with a cam structure.

21. An apparatus for processing fruits and vegetables, comprising:
(a) holders configured for receiving fruits or vegetables having an interior component differing from the surrounding pulp while the fruits or vegetables move in a fixed path;
(b) a cutting device to cut the fruits or vegetables through the interior component while held by the holders moving in the fixed path;
(c) a scraper device to cut the interior component from the surrounding pulp for removal of the interior component from the surrounding pulp while the fruits or vegetables are held by the holders moving in the fixed path.
